(19) United States
(12) Patent Application Publication
(10) Pub. No.: US 2022/0129958 A1
(43) Pub. Date: Apr. 28, 2022

(54) CHANNEL SIGNAL SCORE FOR PRODUCT REVIEWS

(71) Applicant: Channel Signal, Inc., Park City, UT (US)

(72) Inventor: Paul John Kirwin, Park City, UT (US)

(21) Appl. No.: 17/078,803

(22) Filed: Oct. 23, 2020

(51) Int. Cl. G06Q 30/02; G06N 20/00; G06F 16/951; G06F 40/30; G06Q 30/06

(52) U.S. Cl. CPC G06Q 30/0282; G06N 20/00; G06Q 30/0627; G06F 40/30; G06F 16/951

(57) ABSTRACT

Techniques for providing semantic structure to unstructured product reviews and to use the semantically structured reviews to provide an independent score to a product are disclosed. A ML engine identifies websites comprising content describing a product. The ML engine crawls to the websites and extracts sentiment data describing the product. The sentiment data includes unstructured and structured sentiment data. A structured review for the product is generated by determining semantic meanings for the unstructured sentiment data. Based on the structured review, a ranking score for the product is generated.

### BACKGROUND

Electronic commerce, or “e-commerce,” is an economic or business model that provides individuals, businesses, or other entities the option to buy and/or sell products or services over a networked connection, such as the Internet. E-commerce may occur between individuals, businesses, governments, or any entity, without limit. Any type of product or service may be sold using the e-commerce methodology.

A whole new pattern of purchasing and selling behavior has developed as a result of the e-commerce model. For instance, users are able to add items to an electronic shopping cart and then wait to buy those items for a number of minutes, hours, or even days. FIG. 1 provides a helpful illustration.

Specifically, FIG. 1 illustrates an example user interface 100 depicting a shopping cart 105. A user has added an item 110 to the shopping cart 105 to indicate the user would like to buy that item 110. Often, however, users will not immediately buy the item; instead, they may wait a period of time to “think over” the purchase. Sometimes, a user may add an item to the shopping cart 105, and then later decide not to purchase the item. It is often the case, then, that the user will close the user interface 100 with the item 110 still in the shopping cart 105. For instance, the user may select the close option 115 using a cursor 120. Abandoning the purchase is referred to as cart abandonment 125. That is, cart abandonment 125 refers to a scenario in which a user has added an item to his/her electronic shopping cart, but then the user refrains from completing the purchase of that item, whether as a result of deleting the item from the shopping cart, navigating away from the shopping cart, or even closing down the user interface displaying the shopping cart. In this regard, cart abandonment 125 refers to any scenario where a user has previously added an item to his/her electronic shopping cart but then later does not finalize or complete the purchase of that item.

When an item is added to a user's electronic shopping cart, it is often the case that a hold is placed on that item while it is in the user's cart. This hold prevents other users from being able to purchase that particular item for a period of time. For instance, suppose a merchant has a limited number of a particular type of item. When a user adds the item to his/her shopping cart, the user is in effect reserving that item for him/herself. If the user adds the item to his/her shopping cart, but then later does not actually buy the product, it may be the case that the user has prevented other users from purchasing that product during the time the product was in the shopping cart. FIG. 2 illustrates an example inventory 200 and a product 205 in that inventory 200. If the user adds the product 205 to his/her electronic shopping cart, then a hold may be placed on the product 205, thereby preventing other users from purchasing that product 205. If the user waits for a prolonged period of time before purchasing or abandoning his/her shopping cart, then a hold may be placed on that product for the entire period of time. Such holds can be quite frustrating for merchants and even for other users who are desirous to obtain the product.

Cart abandonment is a serious issue that is impacting many merchants. Indeed, it is estimated that cart abandonment occurs as much as 70% of the time when items are added to electronic shopping carts. That is, for every 10 instances in which an item is added to an electronic shopping cart, 7 of those 10 instances will result in cart abandonment.

There are various reasons as to why cart abandonment occurs. One reason may be that the user wants to “sit” on the potential purchase for a period of time to make sure he/she actually wants the product. Another reason may be that the user is hesitant to purchase the product after learning of additional expenses that may occur, such as shipping costs, insurance costs, or return policy costs. Yet another reason may be due to how long it may take for the product to arrive at the user's location. Another reason is that perhaps the user does not want to sign up for the merchant's distribution list or create an account. In any event, there are numerous reasons as to why users may abandon an electronic shopping cart. Accordingly, cart abandonment leads to many issues, including disadvantageous holds on inventory. What is needed, therefore, is a technique designed to help mitigate cart abandonment.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

The embodiments disclosed herein relate to systems, devices (e.g., wearable devices, hardware storage devices, mobile devices, etc.), and methods for providing semantic structure to unstructured product reviews of a product, where the product reviews are obtained from multiple different sources. The embodiments also use the semantically structured reviews to provide an independent score to the product, which score is designed to help reduce cart abandonment.

In some embodiments, a machine learning (ML) engine is used to identify one or more websites comprising content describing a particular product. The ML engine crawls to the websites to extract, from the content included within the web sites, sentiment data describing the product. Here, the sentiment data comprises unstructured sentiment data and structured sentiment data. A structured review for the product is generated by causing the ML engine to use natural language processing (NLP) to determine semantic meanings for the unstructured sentiment data. The review is also generated by combining the now-structured semantic meanings with the structured sentiment data. Based on the structured review, a ranking score for the product is generated. Additionally, a scoring indicator is displayed within a user interface that includes a selectable option for purchasing the product. The scoring indicator is displayed at a location proximate to the selectable option. Notably, the scoring indicator includes i) the ranking score for the product, ii) a number of reviews that were examined to generate the structured review, and iii) a graphic that provides a visual cue reflecting a breakdown of how the ranking score was generated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example user interface depicting an electronic shopping cart.

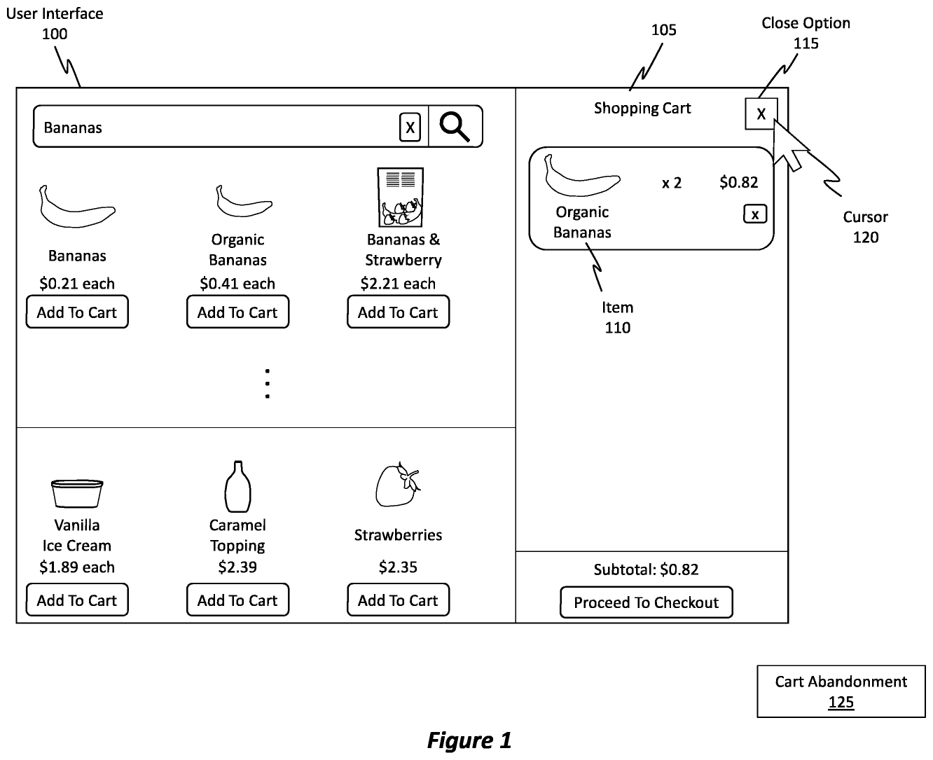

FIG. 2 illustrates how, when items are added to an electronic shopping cart, a hold on those items is often implemented, thereby making those items unavailable for a period of time.

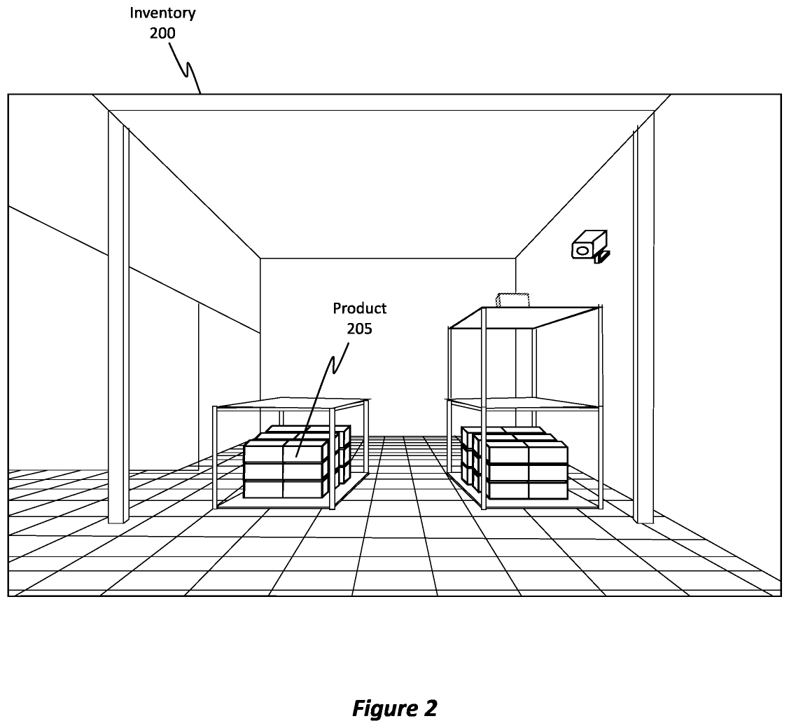

FIG. 3 illustrates an example computing architecture in which the embodiments may be practiced.

FIG. 4 illustrates an example user interface that has been configured to visually display an independent ranking score for a product.

FIG. 5 illustrates an example user interface focused on an electronic shopping cart, where the user interface is also configured to display the ranking score.

FIG. 6 illustrates how an electronic shopping cart may include any number of products and how the user interface can be configured to display ranking scores for each one of the different products.

FIG. 7 illustrates various features and characteristics associated with the ranking score.

FIG. 8 illustrates how the ranking score is often displayed near or proximate to a selectable option for purchasing a product.

FIG. 9 illustrates an expand option that, when selected, enables additional ranking information to be displayed regarding a particular product.

FIG. 10 illustrates some of the additional ranking information that may be displayed.

FIG. 11 illustrates specific features of the additional information.

FIG. 12 illustrates various categories that may be considered when ranking products.

FIG. 13 illustrates an example computing architecture or flow process that may be used to determine characteristics of a particular product.

FIG. 14 illustrates an example interface that provides sentiment data about a particular product.

FIG. 15 illustrates another example interface that provides sentiment data about a product.

FIG. 16 illustrates a continuation of the previously recited computing architecture and flow, which architecture and flow may be used to generate a ranking score for a particular product.

FIG. 17 illustrates an example user interface that is displaying a ranking score.

FIG. 18 illustrates a flowchart of an example method for generating a ranking score for a particular product.

FIG. 19 illustrates an example of a computer system capable of performing any of the disclosed operations.

### DETAILED DESCRIPTION

The embodiments disclosed herein relate to systems, devices (e.g., wearable devices, hardware storage devices, mobile or smart devices, etc.), and methods for providing semantic structure to unstructured product reviews and to use the semantically structured reviews to provide an independent score to a product. It is typically the case that consumers trust only other consumers. The disclosed embodiments provide an independent ranking score to help consumers avoid cart abandonment. The ranking score is also referred to herein as an “online score,” a “channel signal score,” a “ranking score,” and so on.

In some embodiments, a machine learning (ML) engine is used to identify websites comprising content describing a product. The ML engine crawls to the web sites and extracts sentiment data describing the product. The sentiment data includes unstructured and structured sentiment data. A structured review for the product is generated by causing the ML engine to use natural language processing (NLP) to determine semantic meanings for the unstructured sentiment data. The review is also generated by combining the semantic meanings with the structured sentiment data. Based on the structured review, a ranking score for the product is generated. A scoring indicator is displayed within a user interface that includes a selectable option for purchasing the product. The scoring indicator is displayed at a location proximate to the selectable option. Notably, the scoring indicator includes i) the ranking score for the product, ii) a number of reviews that were examined to generate the structured review, and iii) a graphic that provides a visual cue reflecting a breakdown of how the ranking score was generated.

### Examples of Technical Benefits, Improvements, and Practical Applications

The following section outlines some example improvements and practical applications provided by the disclosed embodiments. It will be appreciated, however, that these are just examples only and that the embodiments are not limited to only these improvements.

The disclosed embodiments provide substantial improvements, benefits, and practical applications to the technical field. For instance, the disclosed embodiments help reduce the occurrence of cart abandonment. As a direct result of reducing cart abandonment, the embodiments help mitigate deleterious or disadvantageous effects that result from placing holds or reservations on product inventories. By reducing such holds, the embodiments are able to provide improved product management planning for merchants and improved predictability regarding the availability of products for all users.

The embodiments also provide an improved user experience between a user and a computer system. That is, the embodiments not only provide highly valuable information to a user, but they also present this information in a unique manner within a specialized user interface layout.

An additional beneficial feature is that the embodiments retain anonymity with regard to where and how the product reviews were accessed. For instance, the embodiments are able to access any publicly available product review from any website or content repository. That information is then scraped from the website and aggregated together to thereby preserve privacy with regard to any specific review. That is, the disclosed embodiments refrain from publishing actual product reviews that are obtained from any number of websites. Such data is kept confidential and used only to compute a ranking score. Then, the ranking score is provided to users without providing those users the underlying product reviews that were used to generate the ranking score. Accordingly, these and numerous other benefits will be described in more detail in this disclosure.

### Example Computing Architecture

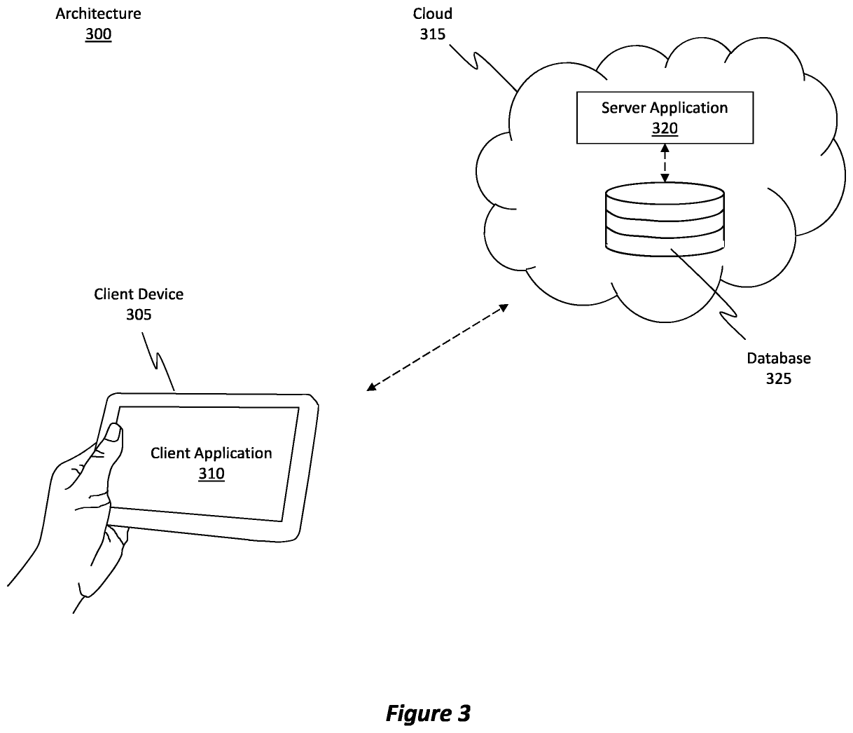

Attention will now be directed to FIG. 3, which illustrates an example computing architecture 300 that includes a client device 305 executing a client application 310. The client device 305 is communicating with a cloud 315 environment comprising a server application 320 utilizing information included in a database 325 or other information repository. The architecture 300 may be used by the disclosed embodiments to generate a ranking score for a particular product, as was introduced above and as will be discussed in more detail later.

The client device 305 may be any type of computing device, including mobile devices and non-mobile devices. For instance, the client device 305 may include any type of smart phone or Internet-of-Things (TOT) device, laptop or desktop, tablet, and so forth, without limit. The client device 305 is able to communicate with the cloud 315 via a telecommunications network (e.g., 3G, 4G, 5G, etc.) or via another networked connection, such as a Wi-Fi network or a wired ethernet connection. The client application 310 may be an application or “app” installed on and executing on the client device 305 itself, or it may be a web service accessed by the client device 305 over a network connection.

The server application 320 is able to host content, such as the content included in the database 325, and provide that content to the client device 305 (e.g., to the client application 310). The server application 320 can also provide any number of services to the client application 310. Indeed, the server application 320 may provide any of the services or features recited herein. Accordingly, the architecture 300 may be used to facilitate the disclosed principles.

### Example User Interfaces for Presenting Ranking Scores

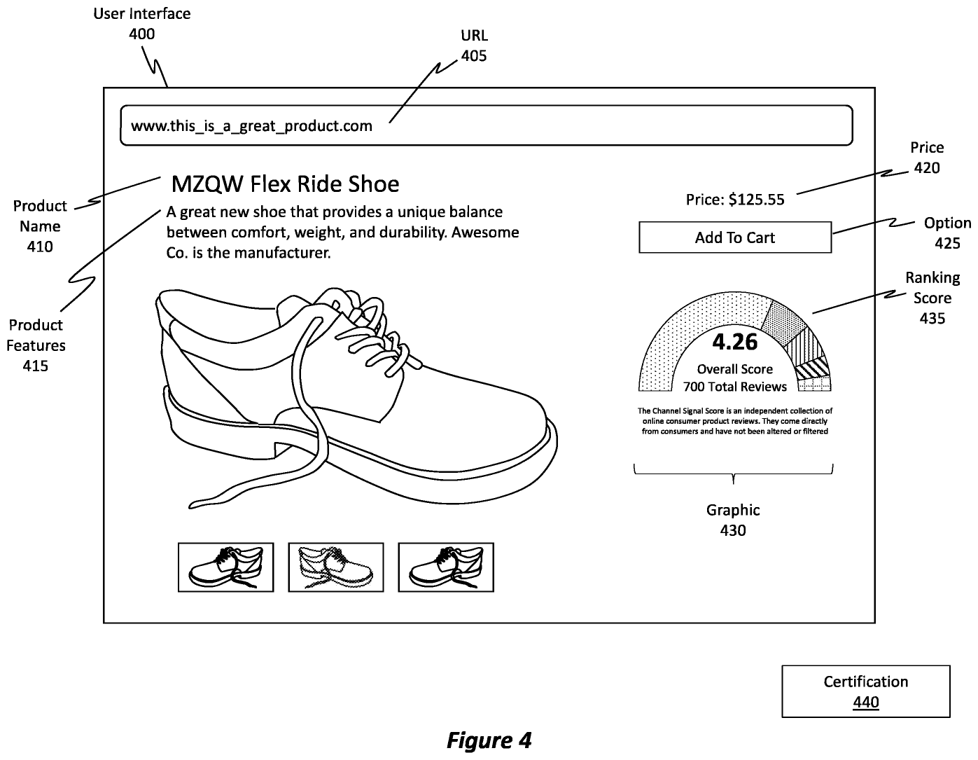

FIG. 4 illustrates an example user interface 400, which may be implemented by the client application 310 in FIG. 3 and/or displayed on the client device 305. User interface 400 is an example interface used to display information and purchase options for a particular product. For instance, user interface 400 is displaying information associated with a uniform resource locator URL 405 for a product having a product name 410 (e.g., “MZQW Flex Ride Shoe”) and having product features 415 (e.g., the manufacturer is “Awesome Co.”). The user interface 400 is displaying numerous different pieces of information about the product, including a price 420 for that product, the manufacturer, etc. Notice, also, the user interface 400 includes an option 425 to purchase the product. For instance, when the option 425 is selected, the underlying service may add the product to the user's electronic shopping cart.

The disclosed embodiments beneficially modify or augment the user interface 400 to include additional information designed to reduce or eliminate cart abandonment. In particular, the embodiments augment the user interface 400 to include a graphic 430 comprising a ranking score 435. The ranking score 435 is an independent collection of online consumer product reviews. This ranking score 435 is generated based off of information that comes directly from consumers, without alteration or filtering.

In effect, the ranking score 435 operates as an independent certification 440 regarding the quality and other characteristics of the underlying product for which the ranking score 435 is being provided. The ranking score 435 is provided to help users improve their decision making processes by providing those users with additional information they might otherwise not be able to acquire. That is, the embodiments acquire and extract information from any number of sources in order to compile information describing the product in various different ways. This compiled information is then analyzed and a ranking score for the product is generated based on that information. By providing this enhanced information directly to a user in a product's website, the embodiments are able to help users decide whether or not they actually want to purchase the item, thereby reducing or eliminating cart abandonment. Additional information describing the details of a ranking score, including how it is generated, will be provided later. For now, the next few figures will describe visual aspects of the ranking score. Accordingly, the graphic 430, which includes the ranking score 435, is located within the user interface 400 at a location that is beneficially near or proximate to the option 425 used to purchase a product. Additional details regarding these features will be provided later.

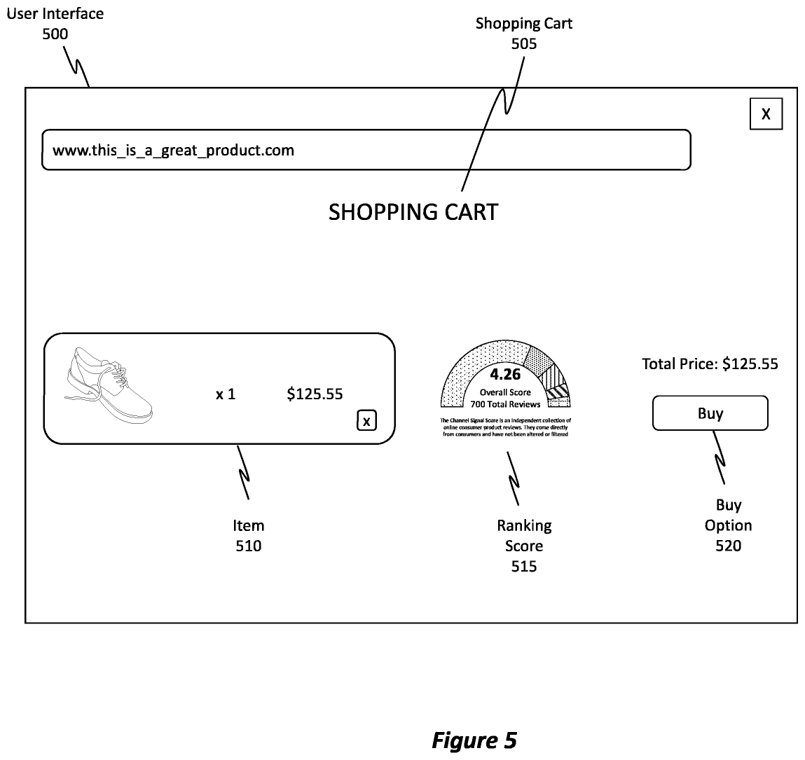

FIG. 5 illustrates another example user interface 500, similar to the user interface 400 of FIG. 4. Here, however, user interface 500 is displaying an electronic shopping cart 505. An item 510 has been added to the shopping cart 505 for purchase. The user interface 400 of FIG. 4, on the other hand, was focused on an interface where a user can add an item to a shopping cart.

In accordance with the disclosed principles, the embodiments are also able to display a ranking score 515 (aka a “scoring indicator”) for the item 510 within the shopping cart 505. Notice, here, the ranking score 515 may also be displayed proximately to the buy option 520 which, when selected, initiates the transaction or the purchase of the item 510. Accordingly, ranking scores may be displayed near buy options and also options to add an item to a shopping cart.

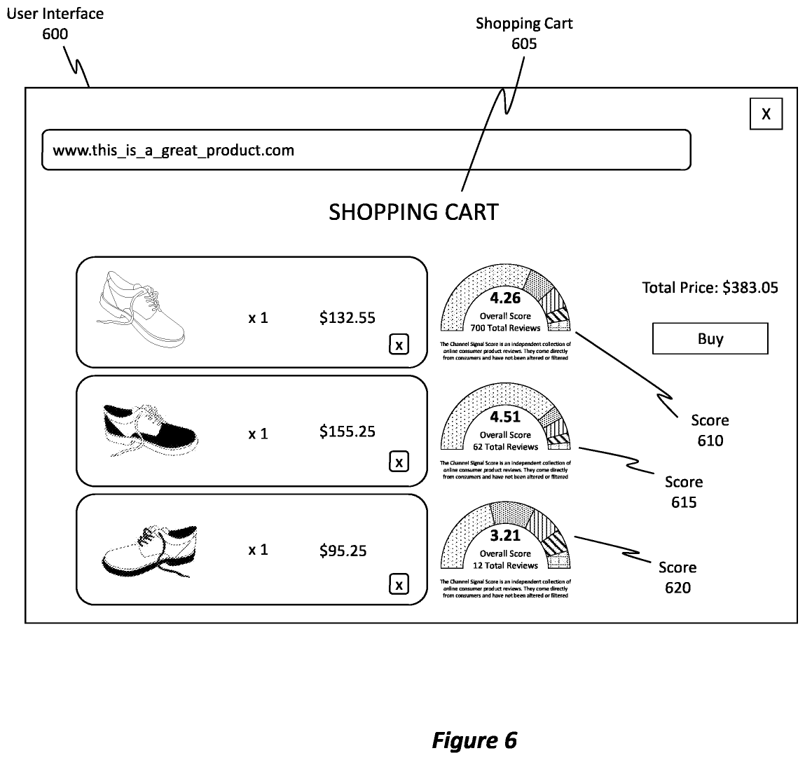

FIG. 6 further expands on the concepts taught in FIG. 5. Specifically, FIG. 6 shows an example user interface 600 displaying a shopping cart 605. Here, a number of items (not labeled) have been added to the shopping cart 605. For each respective one of these items, a corresponding score is visually displayed in the user interface 600. For instance, the first shoe item with a price of $132.55 has a ranking score 610, the second shoe item with a price of $155.25 has a ranking score 615, and the third shoe item with a price of $95.25 has a ranking score 620. Each item added to a shopping cart may have its own corresponding ranking score. That is, the user interface displaying a shopping cart may be augmented to display corresponding ranking scores for each item in the shopping cart.

In some cases, every item is enabled to have its own corresponding ranking score. In some cases, only a select number of items have corresponding scores. For instance, in some embodiments, a threshold price limit may be established where only items whose prices exceed that threshold price limit will have a ranking score displayed in the user interface. By way of a specific example, the threshold price limit may be $25. For every item added to the shopping cart whose price is under $25, those items may not have a corresponding ranking score displayed. On the other hand, for every item added to the shopping cart whose price is $25 or more, those items may have a corresponding ranking score displayed.

In some embodiments, different display criteria may be established to determine whether or not a ranking score is to be displayed. For instance, one display criteria may be the size of the screen that is displaying the shopping cart. If the size of the screen is below a threshold screen size, then the embodiments may refrain from displaying the ranking score and may instead display a selectable option that, when selected, causes the ranking score to be displayed. In this regard, the embodiments can save on limited screen “real estate.” Another display criteria for displaying the ranking score may be based on product category or product type. For instance, products that are determined to be so-called “staple” items, such as perhaps food, clothing, etc. may refrain from having a ranking score displayed. On the other hand, products that are not staple items but rather are luxury or non-essential items may have a ranking score displayed. Accordingly, any display criteria may be used to determine whether or not to display a ranking score.

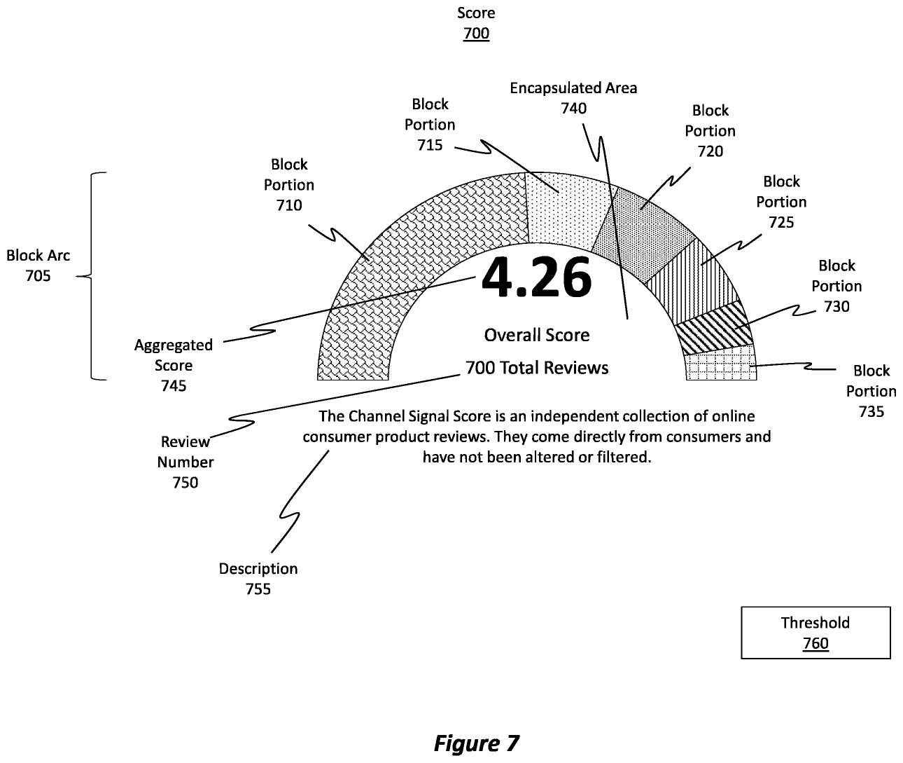

FIG. 7 illustrates a score 700, which is representative of the ranking scores mentioned thus far, including scores 610, 615, and 620 from FIG. 6. The score 700 is formed from a block arc 705 graphic that includes different block portions forming the arc. For instance, the block arc 705 includes block portion 710, block portion 715, block portion 720, block portion 725, block portion 730, and block portion 735. Although only six block portions are illustrated, any number of block portions may be used.

In this particular example (though certainly not all), the score 700 is based on scoring values between 0 (a lowest score) and 5 (a highest score). Of course, other scoring techniques may be used, such as between 0 and 10, 0 and 100, A-B-C-D-F, and so on without limit.

In this example, each of the scoring block portions 710-735 corresponds to one of the scoring increments. For instance, the block portion 710 corresponds to a score value of “5;” block portion 715 corresponds to a score value of “4;” block portion 720 corresponds to a score value of “3;” block portion 725 corresponds to a score value of “2;” block portion 730 corresponds to a score value of “1;” and block portion 735 corresponds to a score value of “0.” Of course, the block portions may be representative of other scoring measures as well.

In this regard, the block arc includes different block portions that each represent a relative scoring percentage contribution that contributed to the ranking score. By way of example, a certain percentage of reviews are determined to correspond to a score value of “5,” a certain percentage of reviews are determined to correspond to a score value of “4,” and so on and so forth. The block arc 705 graphic can be used to visually represent these percentage indications. For instance, a high percentage of reviews, as represented by the lengthened size of block portion 710, correspond to a particular score value. Similarly, a shorter size of block portion 715 correspond to a particular score value, and so on and so forth.

The block arc 705 includes or forms an encapsulated area 740 that is formed from the block portions and an empty space underneath the arc. Within this encapsulated area 740, the embodiments are able to place or visually display different pieces of information.

For instance, an aggregated score 745 may be displayed within the encapsulated area 740. The aggregated score 745 is representative of the ranking scores mentioned thus far. Additionally, the embodiments may display a review number 750 (within the encapsulated area 740) and a description 755 (outside of the encapsulated area 740). The review number 750 refers to or reflects a number of product reviews that have been analyzed in order to generate the aggregated score 745. In this example scenario, 700 total different reviews of the product have been analyzed in order to generate the 4.26 aggregated score 745. The description 755 is listed to provide additional information to a user to help the user better understand how the score 700 was generated. For instance, in this case, the description 755 recites the following text: “The Channel Signal Score is an independent collection of online consumer product reviews.” “They come directly from consumers and have not been altered or filtered.” Of course, other descriptive text may be used as well.

Accordingly, in some embodiments, the block arc encloses an encapsulated area. Optionally, the ranking score and the number of reviews are visually presented within the encapsulated area enclosed by the block arc. Additional details or information may be provided external to the encapsulated area 740.

In some cases, a threshold 760 may be imposed to limit when the score 700 is generated and/or displayed. For instance, the threshold 760 may refer to a minimum number of product reviews that are analyzed in order to generate the aggregated score 745. By way of example and not limitation, the threshold 760 may require at least 10 or 20 or 30 or “x” number of reviews be available and be analyzed in order to generate the aggregated score 745. If less than the threshold 760 is analyzed, then the embodiments may refrain from displaying a score and may instead display a notification indicating that there were an insufficient number of reviews available in order to provide the score. Providing such a notification helps increase the reliability and trustworthiness of the score because consumers will know that scores are provided only if reliable information about a product is available.

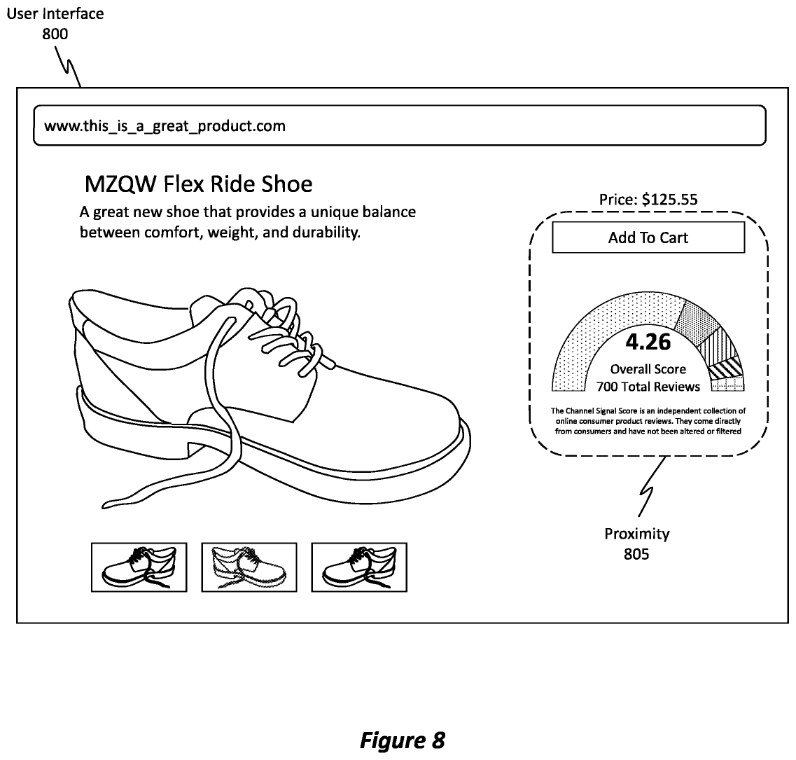

FIG. 8 illustrates an example user interface 800 representative of the user interfaces mentioned thus far. Here, an “Add To Cart” user interface element and the scoring graphic are emphasized with the label proximity 805. Proximity 805 indicates how the scoring graphic is placed at a location proximate to the option to purchase the particular product. Proximity 805 may indicate how the two user interface elements are required to be within a threshold number of pixels relative to one another or a threshold distance (e.g., a certain number of inches) to one another. Any proximity value may be set, but preferably the closer the better.

By placing the scoring graphic proximate to the purchase option, a user will be able to readily view the ranking score and better determine whether he/she actually wants to purchase the product at that time. Doing so provides enhanced information to the user, thereby reducing the possibility of cart abandonment.

### Ranking Categories

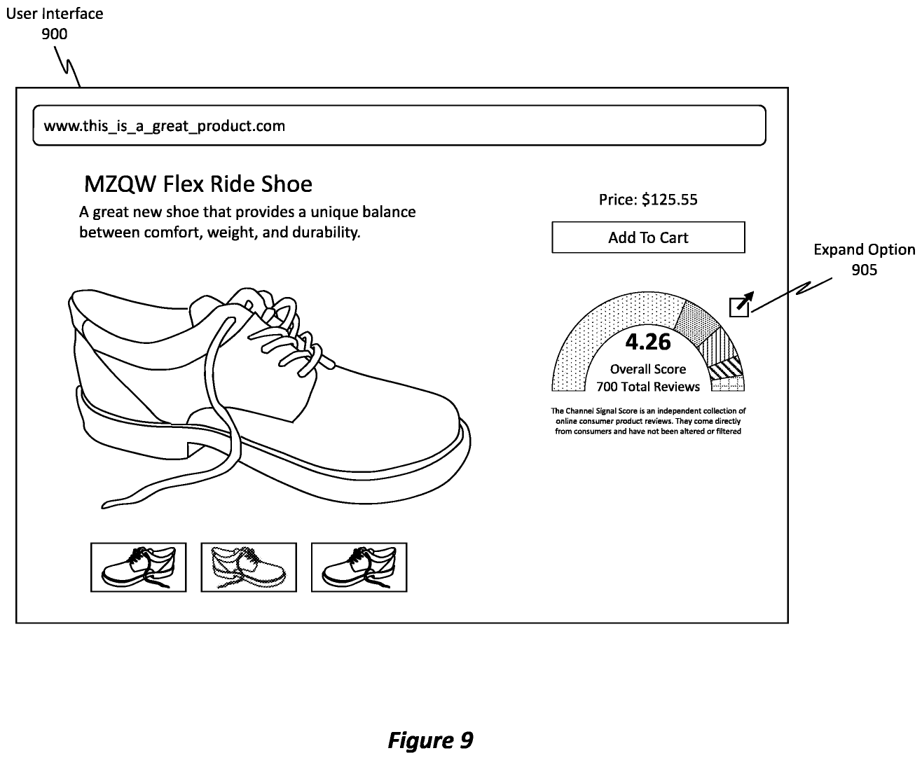

FIGS. 9, 10, 11, and 12 are focused on an additional feature of the ranking score feature recited herein. In particular, FIG. 9 illustrates an example user interface 900, which is representative of the user interfaces mentioned thus far. User interface 900 is specially configured to include a selectable expand option 905 displayed near or proximate to the score graphic. When selected, the expand option 905 provides additional information to a user regarding specific ranking categories that have been identified or developed for the product.

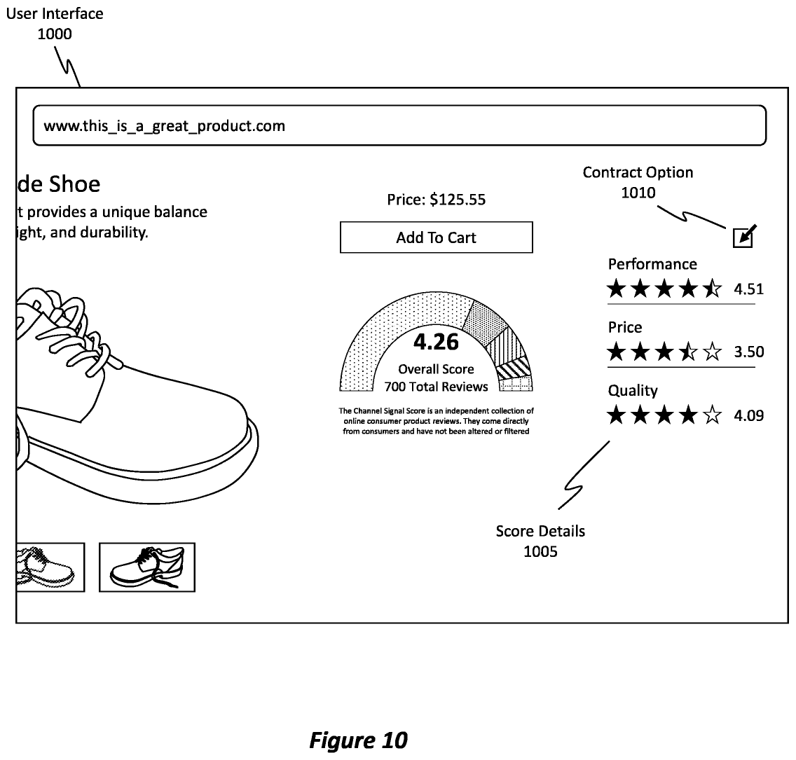

For instance, in response to the expand option 905 being selected, the user interface 1000 of FIG. 10 is displayed. User interface 1000 includes score details 1005 and a contract option 1010. Selection of the contract option 1010 reverts the user interface 1000 back to the state shown in FIG. 9.

The score details 1005 illustrate different categories in which the product (in this case, a shoe) has been ranked. The combination of the scores for each sub-category determines the aggregated or overall score of the product. In this case, the overall or aggregate score is 4.26 out of 5.0 for the shoe. Notice, there are different sub-scores for the different categories illustrated in FIG. 10.

To illustrate, one sub-category is a “Performance” category with a numeric score of 4.51 out of 5.0 and a corresponding “star” score indicator. Another sub-category is a “Price” category with a numeric score of 3.50 out of 5.0 and a corresponding star score indicator. Another sub-category is a “Quality” category with a numeric score of 4.09 out of 5.0 and a corresponding star score indicator. While only three sub-categories are listed, any number of categories may be displayed, without limit. Additionally, the “Performance,” “Price,” and “Quality” categories are examples only; other categories may be used, as will be described in more detail later.

The specifics regarding how the scores are generated will be provided later, but by way of a brief introduction, the embodiments are able to acquire information describing the product and then group that information into different categories. In this case, the categories are the three listed in FIG. 10. Here, the embodiments determined, based on the acquired product review information, that this product (i.e. a shoe) has a performance metric or rating of 4.51 out of 5.0, a price rating of 3.50, and a quality rating of 4.09, where the highest score is a 5.0 and the lowest is a 0.0. In this example scenario, the score details 1005 are displayed proximately to the score graphic and proximately to the purchase option (e.g., “Add To Cart”).

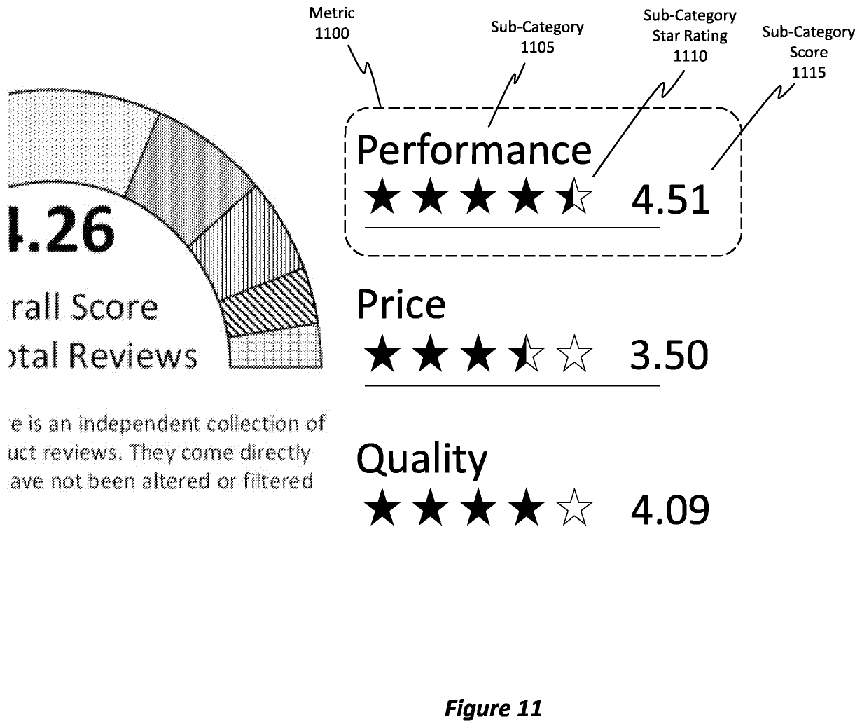

FIG. 11 illustrates additional details regarding the score details 1005 of FIG. 10. FIG. 11 shows a metric 1100 comprising a sub-category 1105 (here the “Performance” sub-category), a sub-category star rating 1110, and a sub-category score 1115. Also shown but not labeled are the metric for the Price category and the metric for the Quality category.

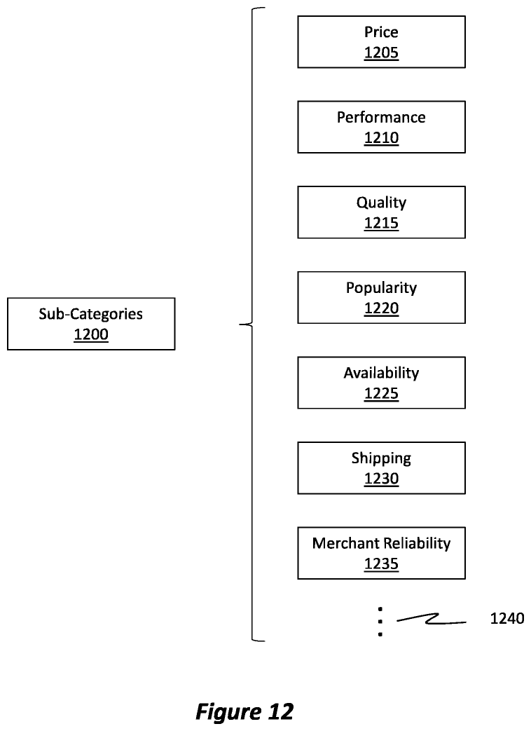

FIG. 12 lists a number of example categories or sub-categories 1200 that may be considered and that may be displayed as a metric in the earlier figures. The sub-categories 1200 include, but certainly are not limited to, a price 1205 category, a performance 1210 category, a quality 1215 category, a popularity 1220 category, an availability 1225 category, a shipping 1230 category, and a merchant reliability 1235 category. The ellipsis 1240 indicates how other categories may be considered as well (e.g., a return policy of the merchant).

The price 1205 category reflects consumers' perceptions regarding the adequacy of the price of a product. For instance, some consumers may consider the listed price to be too high, too low, or just right. The performance 1210 category reflects consumers' perceptions regarding the durability of the product or service. For instance, performance can be the fit or size of the product, the comfort of the product, or even the brand performance of the product. By way of example, “brand performance” can refer to how the company or manufacturer performs overall, the reputation of the manufacturer, and even the customer care quality of the manufacturer (e.g., whether they offer free shipping, on-time guarantees, money back guarantees, etc.). The performance of the manufacturer as a whole can be considered by the disclosed embodiments. The quality 1215 category reflects its quality.

The popularity 1220 category reflects how mainstream or popular the item is relative to other items. The availability 1225 category reflects how readily available the product is (e.g., the number of items in stock and how quickly those items are being sold). The shipping 1230 refers to the quality and speed by which the product is shipped. Finally, the merchant reliability 1235 category refers to the confidence or reputation of the merchant selling the product. Any number of different categories may be developed and may be used to rank a product. Accordingly, the categories listed in FIG. 12 are simply an inexhaustive list of example categories.

In this regard, the ranking score may include an overall score and a sub-category score that lists a particular score for a particular category for which the product is ranked. These scores may be displayed simultaneously with one another within a user interface. In some cases, the sub-category is one of: a price category, a performance category, a quality category, a popularity category, an availability category, a shipping category, or a merchant reliability category.

### Generating Ranking Scores

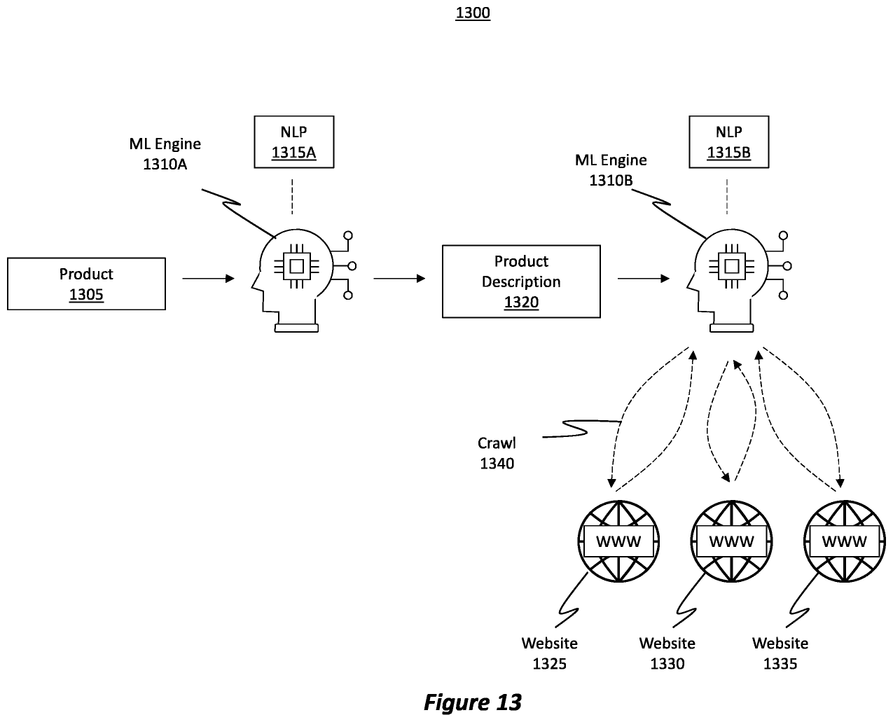

FIG. 13 illustrates an example flow 1300 for generating a ranking score in accordance with the disclosed principles. Initially, a product 1305 is identified, such as the product name 410 from FIG. 4. This product 1305, or rather some initial details of the product 1305, are fed as input into a machine learning ML engine 1310A. For instance, a product's website may be provided to the ML engine 1310A as an initial piece of descriptive information.

Any type of ML algorithm, model, or machine learning may be used. Indeed, as used herein, reference to “machine learning” or to a ML model may include any type of machine learning algorithm or device, neural network (e.g., convolutional neural network(s), multilayer neural network(s), recursive neural network(s), deep neural network(s), dynamic neural network(s), etc.), decision tree model(s) (e.g., decision trees, random forests, and gradient boosted trees), linear regression model(s) or logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some embodiments, the ML engine 1310A uses natural language processing NLP 1315A to analyze the website for the product 1305 to identify the product's product description 1320, which includes information such as the product name, manufacturer, make, model, version number, creation date, and so forth. By way of example, the NLP 1315A engine is able to parse and identify information from a website in various different ways.

For instance, the NLP 1315A engine is able to utilize any type of optical character recognition (OCR) to identify and determine text that is recognizable. The NLP 1315A engine is also able to perform word segmentation (often called tokenization) in order to separate bodies of text into different words. The NLP 1315A engine is also able to perform a morphological analysis on the text, such as by performing morphological segmentation or even part-of-speech tagging. The NLP 1315A engine is also able to perform syntactic analysis to identify the underlying syntax of words describing the item. By way of example, the NLP 1315A engine can perform both dependency parsing (i.e. identifying relationships between words in a sentence) and constituency parsing (i.e. generating a parse tree based on the relationship between the words). The NLP 1315A engine can also perform any type of lexical semantics, distributional semantics, named entity recognition, sentiment analysis, terminology extraction, and even word sense disambiguation. Accordingly, the NLP 1315A engine is able to perform any type of natural language processing to identify features of a product, including the product's general product category (e.g., what the item “is” in a general sense) and supporting product details of the item (e.g., specific or granular characteristics of the item).

Accordingly, the ML engine 1310A, or rather the NLP 1315A engine, is able to analyze the product's website to identify specific features about the product 1305, as illustrated by the product description 1320. By way of another example, the ML engine 1310A is able to analyze the website represented by the URL 405 in FIG. 4 to identify the product name 410 and the product features 415. The ML engine 1310A is able to identify a make and manufacturer (e.g., “Awesome Co.” is the manufacturer) of the product and even a product version of the product. Using this information, the ML engine 1310A is then able to definitively identify the specific product in other websites that are also describing or perhaps selling the product. For instance, the URL 405 from FIG. 4 may be a URL owned and managed by a manufacturer of the MZQW Flex Ride shoe. It is beneficial, however, to review other websites that also sell the product in order to obtain additional information about the product, including sentiment data about the product.

As used herein, “sentiment” data refers to any type of data describing attributes or qualities of a product, where that sentiment data was generated by consumers of the product and not necessarily by a biased party (e.g., a manufacturer of the product). This sentiment data may be distributed across any number of websites, including a manufacturer's own website. By way of example, a website may list product reviews of a product, where the product reviews are provided by consumers or purchasers of the product. The embodiments are able to navigate to these product reviews and identify the sentiment data. That data may then be analyzed to determine whether the product reviews reflect positive, negative, or neutral views of the product. Using that sentiment data, the embodiments are then able to generate a ranking score to inform potential buyers of past buyers' views of the product.

FIG. 13 illustrates a portion of this process using the ML engine 1310B, which may be the same as the ML engine 1310A, and the NLP 1315B engine, which may be the same as the NLP 1315A engine. In any event, the ML engine 1310B is able to use the product description 1320 to then facilitate, coordinate, or even perform a search on the Internet to identify other websites (e.g., website 1325, website 1330, and website 1335) that include content also describing the product 1305.

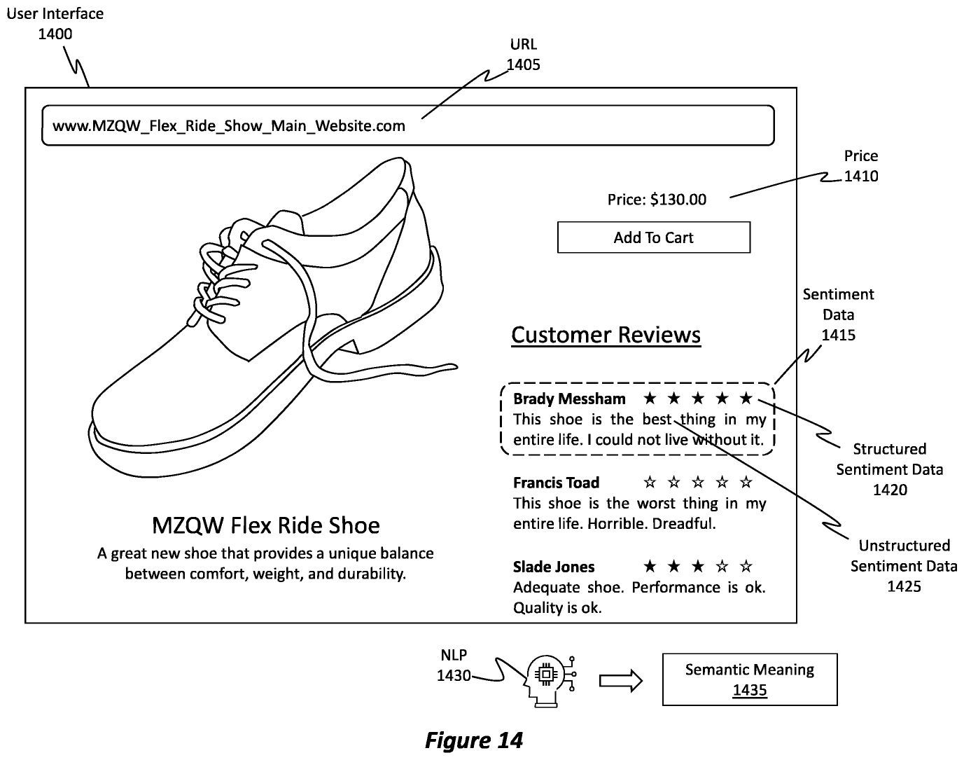

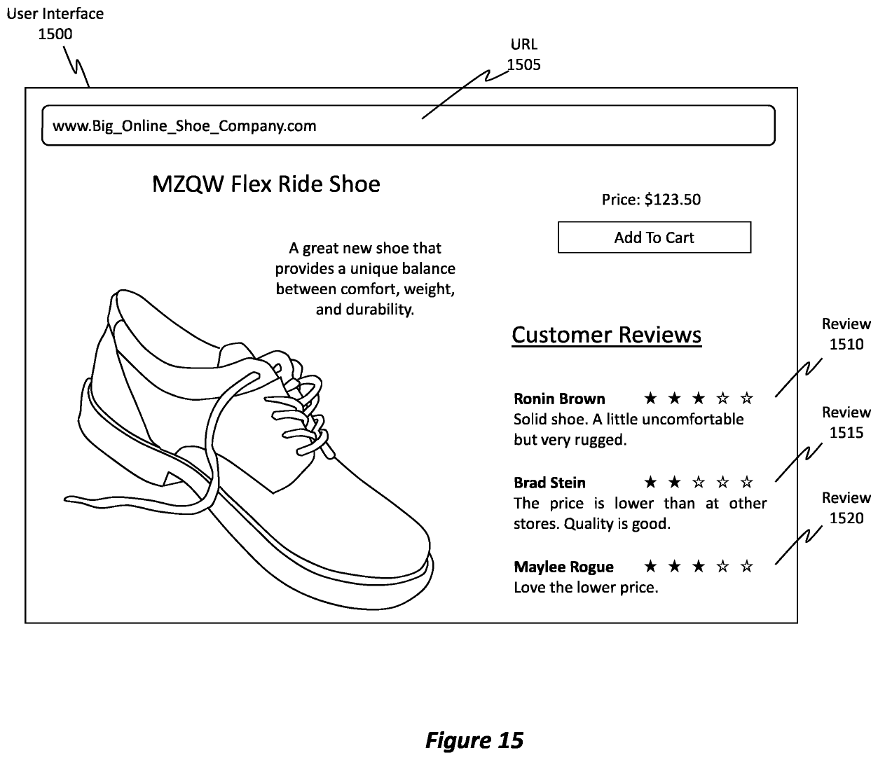

By way of example, websites 1325-1335 may be third-party websites that sell products, such as perhaps Amazon, Ebay, Newegg, Craigslist, and so on. The ML engine 1310B is then able to crawl 1340 to each one of these websites in an attempt to identify and extract sentiment data about the product 1305. FIGS. 14 and 15 are representative of these operations.

Specifically, FIG. 14 illustrates a user interface 1400 displaying content associated with a URL 1405. In this example scenario, the URL 1405 is owned and managed by the manufacturer of the product (e.g., the “MZQW Flex Ride Shoe”). The user interface 1400 is displaying the price 1410 of the product as well as sentiment data 1415 (i.e. product reviews).

The sentiment data 1415 includes both structured sentiment data 1420 and unstructured sentiment data 1425. To illustrate, the structured sentiment data 1420 is evidenced in the form of a discrete star rating that has been assigned to the product by a particular consumer. In the “Brady Messham” rating example, Brady has given the product a 5-star rating. In the “Francis Toad” example, however, Francis has given the product a 0-star rating. In the “Slade Jones” example, Slade has given the product a 3-star rating. This star-based rating is considered “structured” because a definitive, non-lexical rating classification is being used to describe the product. In contrast, “unstructured” sentiment data uses lexicology (e.g., descriptive words) to rate a product.

For instance, the unstructured sentiment data 1425 is saying the following: “This shoe is the best thing in my life.” “I could not live without it.” These words are describing the underlying thoughts and feelings the reviewer has towards the product while the star ratings in the structured sentiment data 1420 are providing a numeric rating and are thereby structured for the product. In order to understand the reviewer's viewpoint of the product based on the unstructured sentiment data 1425, the NLP engine mentioned earlier parses and tokenizes the words in the review and applies a semantic understanding to those words. That is, the NLP 1430 engine, which is representative of the NLP engines mentioned earlier, parses the text and determines a semantic meaning 1435 for the unstructured sentiment data 1425.

In this case, the unstructured sentiment data 1425 reflects a positive review or a positive viewpoint of the product (e.g., the product is the “best” thing in the reviewer's life). In contrast, the unstructured sentiment data provided by “Francis Toad” reflects a negative viewpoint of the product. For instance, the text—“This shoe is the worst thing in my life.” “Horrible.” “Dreadful.”—clearly represents a negative viewpoint of the product. On the other hand, the unstructured sentiment data provided by “Slade Jones” reflects a neutral viewpoint of the product, as represented by the following text—“Adequate shoe.” “Performance is ok.” “Quality is ok.”

The NLP 1430 engine is able to parse the text provided in the unstructured sentiment data to determine that text's semantic meaning. To do so, the NLP 1430 engine is able to compare and contrast the text against a repository, storehouse, or database of other sentiment data to determine whether the combination of words reflects positive, negative, or neutral feelings towards the product. The NLP 1430 engine may be trained over time to continuously improve its semantic understanding of text, words, and phrases. In some cases, a lexical or semantic dictionary may be maintained by the NLP 1430 engine and may be updated over time to reflect an improved understanding of language meaning.

FIG. 15 illustrates a different user interface 1500 for a URL 1505. Whereas URL 1405 of FIG. 14 was that of a manufacturer of the product, the URL 1505 is that of a third-party website that sells products. The disclosed embodiments, and in particular the disclosed ML engines, are able to use the previously acquired product information in order to conduct a search to find other websites that include content describing the product, including sentiment data about the product.

For instance, similar to user interface 1400, user interface 1500 is also listing or displaying sentiment data about the particular product. Specifically, user interface 1500 is listing review 1510, review 1515, and review 1520. Each one of these reviews includes both structured sentiment data (e.g., in the form of a star rating) and unstructured sentiment data (e.g., in the form of text-based descriptions).

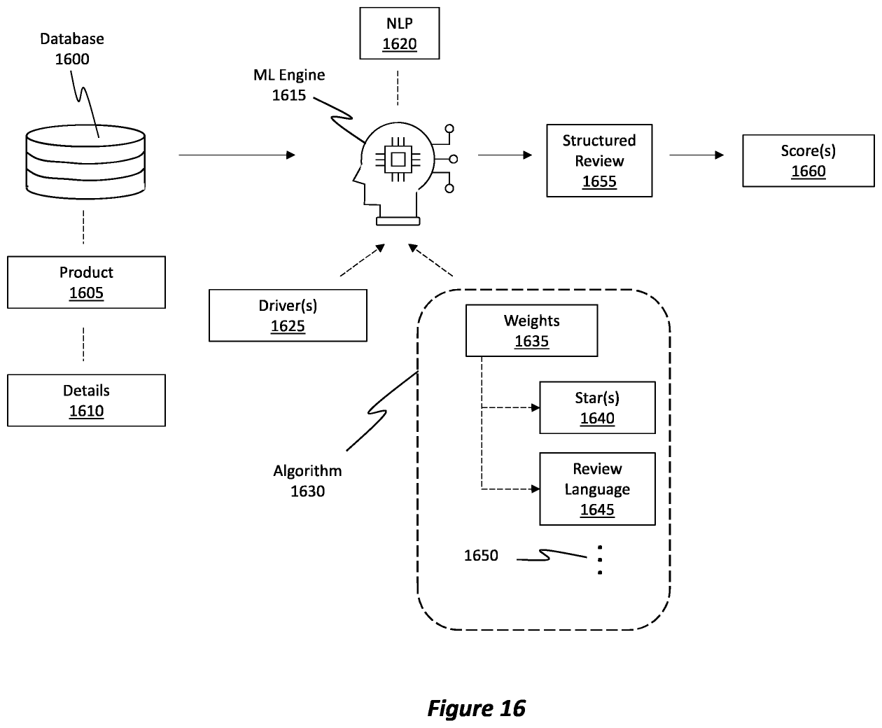

The review 1510 provided by Ronin Brown describes the product using a three out of five star structured sentiment data. Additionally, the review 1510 states the following: “Solid shoe.” “A little uncomfortable but very rugged.” These statements express both positive reviews (e.g., “Solid shoe” and “very rugged”) and negative reviews (e.g., “A little uncomfortable”). On its whole, therefore, the positive and negative reviews likely balance one another out, thereby providing a generally neutral sentiment toward the product. The disclosed NLP engine is able to analyze the views and sentiment expressed in review 1510 and determine how the reviewer feels about the product. A similar semantic analysis may be performed on the reviews 1515 and 1520. In this regard, the embodiments are able to provide structure to an unstructured review. The embodiments are able to use both the structured review and the now-structured but previously unstructured review to generate an overall understanding of the product. The embodiments are able to repeatedly perform these processes in order to generate an overall ranking score for the product, as will be described in more detail to follow. FIG. 16 more fully elaborates on the processes just described.

FIG. 16 shows a database 1600 comprising information about a product 1605 and details 1610 of that product 1605. For instance, the details 1610 may be the product description 1320 of FIG. 13. A ML engine 1615, which utilizes NLP 1620 and which is representative of the ML engines and NLP engines mentioned thus far, is able to analyze the contents of the database 1600 in order to generate an aggregated ranking score for a particular product. The ML engine 1615 includes any number of driver(s) 1625, threads, neural networks, or components to analyze the details 1610.

Furthermore, the ML engine 1615 includes an algorithm 1630 that is designed to analyze and weight the information included in the product details in order to generate a score. Specifically, the algorithm 1630 considers different weights 1635 that may be applied to different pieces of information. For instance, one weight may be applied to the star(s) 1640 information that is acquired while a different weight may be applied to the review language 1645 (i.e. the text). The ellipsis 1650 indicates how weights may be applied to other information as well.

Different weights are used because it may be the case that there is a disparity between the acquired details. For instance, one reviewer may have provided a product with a five out of five star rating, but then used specific review language to disparage the product. In this case, the action of writing language disparaging the product may more accurately reflect the reviewer's viewpoint of the product because it takes more deliberation and focus to write disparaging language than it does to simply select a number of stars. As such, the textual language may better reflect the consumer's true viewpoint. In this example case, therefore, the embodiments may weight more heavily the review language 1645, or rather, may cause the review language 1645 to more dramatically influence the resulting score as compared to the star(s) 1640. The contrary may also be true, where the star(s) 1640 are weighted more heavily than the review language 1645 (e.g., in a case where 5 out of 5 stars were awarded, but only a “ok” or other simplistic language was used).

The ML engine 1615 reviews and analyzes the identified sentiment data and provides structure (i.e. semantic meaning) to any reviews that were originally unstructured (e.g., unstructured sentiment data). As a result of performing these actions, the ML engine 1615 generates a structured review 1655. Based on that structured review 1655, the ML engine 1615 is then able to generate a ranking score or score(s) 1660 for the product. For instance, the aggregated score 745 shown in FIG. 7 is one example of the score(s) 1660. Likewise, the sub-category score 1115 of FIG. 11 is another example of the score(s) 1660. The embodiments are able to generate an overall or aggregated score for the product based on the entirety of the information and are also able to generate sub-scores focused on specific categories of the product.

By way of additional clarification, the overall or aggregated score is based on a totality of all of the acquired product reviews. The sub-scores, on the other hand, are based on reviews specifically highlighting certain categories in which the product is being ranked, such as perhaps in quality or price or any of the categories mentioned earlier in connection with FIG. 12. In some embodiments scores from one category may be weighted more or less than scores from other categories, such that the overall or aggregated score is influenced by the weighting. For instance, product “quality” may be weighted more heavily than “speed” of shipping.

Accordingly, the embodiments are able to search the Internet to identify sentiment data about a particular product. The embodiments are then able to apply a semantic meaning or understanding to the sentiment data in order to structuralize or provide structure to that sentiment data. Now that a structured review is generated, the embodiments can compile all of the structured reviews and generate one or more scores that rank the product in an overall manner as well as in any number of specific categories. By performing these operations and then by visually displaying the score information, the embodiments are able to help reduce cart abandonment, thereby improving inventory management and availability, quality control, and merchant reliability.

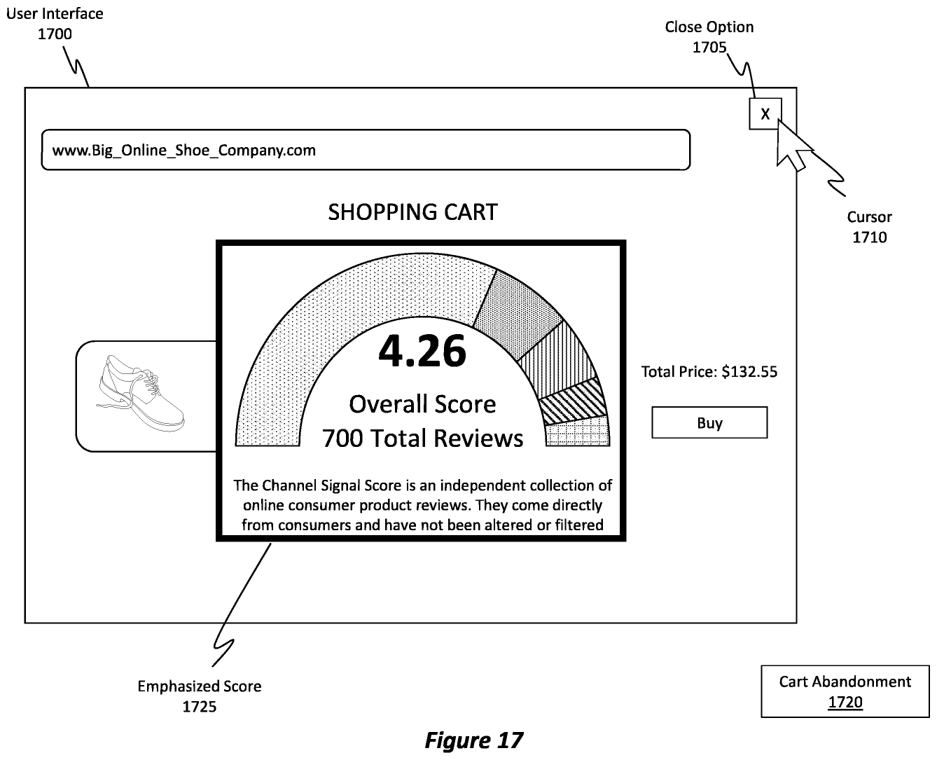

FIG. 17 illustrates another or supplemental technique designed to help reduce cart abandonment. Specifically, FIG. 17 shows a user interface 1700 that includes a close option 1705. When selected (e.g., using the cursor 1710 or some other selection mechanism, such as a touch input), the close option 1705 operates to navigate away from the shopping cart in which a consumer has added goods or services, thereby leading to cart abandonment 1720. In an effort to further combat cart abandonment 1720, some embodiments emphasize the ranking score in an effort to dissuade the consumer from abandoning the cart. For instance, the emphasized score 1725 may be provided.

In this example, the emphasized score 1725 is an enlarged score as compared to the sizes of the previous scores. For instance, in response to the cursor 1710 hovering over or approaching the close option 1705, some embodiments emphasize the score by making the score graphic larger (as in FIG. 17). Other emphasizing techniques may be used as well. For instance, the score may be highlighted, it may blink, a sound or alarm may be raised, and so forth. Any combination of these emphasizing techniques may be performed as well.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

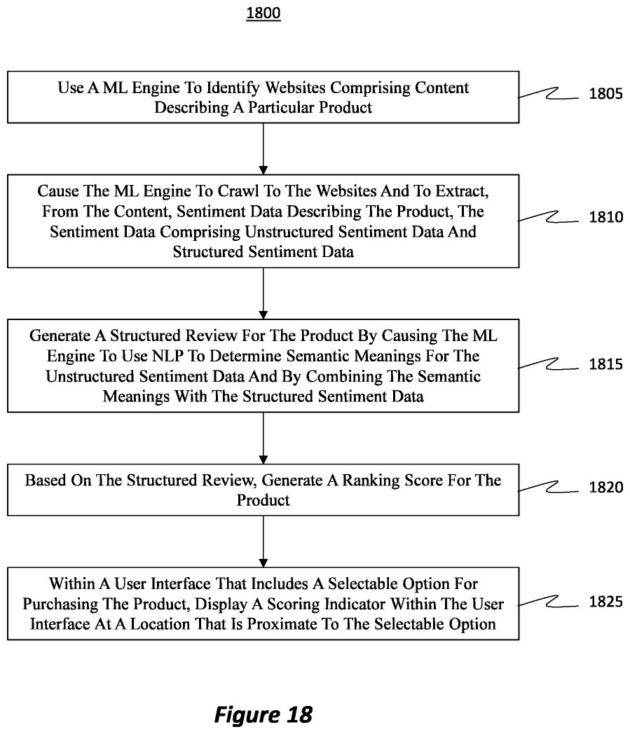

FIG. 18 illustrates a flowchart of an example method 1800 that may be performed by the client device 305 of FIG. 3 and/or that may be implemented using the computing architectures and flows mentioned herein. For instance, the computing system implementing method 1800 may be configured to provide semantic structure to unstructured product reviews of a product, where the product reviews are obtained from multiple different sources, and to use the semantically structured reviews to provide an independent score to the product.

Initially, method 1800 includes an act (act 1805) of using a machine learning (ML) engine (e.g., ML engine 1310A or 1310B from FIG. 13 and/or ML engine 1615 from FIG. 16) to identify one or more websites (e.g., websites 1325-1335 from FIG. 13) comprising content (e.g., sentiment data 1415 from FIG. 14, and reviews 1510-1520 from FIG. 15) describing a particular product. Optionally, this process (i.e. identifying the one or more websites comprising the content describing the particular product) may be performed by first identifying a name and product features of the product and then performing a search using the name and product features to identify the websites. Beneficially, it is often the case that the websites include a website not managed by a manufacturer of the product; instead, the web site may be managed or owned by a third-party entity.

Act 1810 involves causing the ML engine to crawl to the one or more websites and to extract (e.g., from the content included within the one or more websites) sentiment data (e.g., sentiment data 1415 of FIG. 14) describing the product. Here, the sentiment data comprises unstructured sentiment data (e.g., unstructured sentiment data 1425) and structured sentiment data (e.g., structured sentiment data 1420). By way of example, the unstructured sentiment data may include text descriptions of the product, and the structured sentiment data may include a star rating describing the product.

Act 1815 involves generating a structured review (e.g., structured review 1655 of FIG. 16) for the product by causing the ML engine to use natural language processing (NLP) to determine semantic meanings for the unstructured sentiment data and by combining the semantic meanings with the structured sentiment data.

Based on the structured review, method 1800 then includes an act (act 1820) of generating a ranking score for the product. In some implementations, the ranking score includes an overall score and a sub-category score that lists a particular score for a particular category for which the product is ranked. Optionally, the process of generating the ranking score for the product is performed by weighting text descriptions of the product differently than weighting star ratings of the product.

Subsequently, within a user interface that includes a selectable option (e.g., option 425 of FIG. 4, buy option 520 of FIG. 5, and so on) for purchasing the product, there is an act (act 1825) of displaying a scoring indicator (e.g., ranking score 435 of FIG. 4, the ranking score 515 of FIG. 5, the scores 610-620 of FIG. 6, and so on) within the user interface at a location that is proximate to the selectable option. Notably, the scoring indicator includes i) the ranking score (e.g., the aggregated score 745 of FIG. 7) for the product, ii) a number of reviews (e.g., review number 750) that were examined to generate the structured review, and iii) a graphic (e.g., graphic 430 of FIG. 4) that provides a visual cue reflecting a breakdown of how the ranking score was generated. In some cases, the graphic may be a block arc comprising different block portions that each represent a relative scoring percentage contribution that contributed to the ranking score.

In some implementations, the scoring indicator includes a selectable expand option that, when selected, causes the user interface to further display a sub-score for a sub-category for which the product is ranked, as demonstrated in FIGS. 9 and 10. Optionally, the selectable option for purchasing the product is included within an electronic shopping cart. As another option, the scoring indicator may be emphasized in response to a determination a user of the user interface is attempting to navigate away from the user interface.

In some embodiments, displaying the scoring indicator is performed when the number of reviews that were examined to generate the structured review satisfies a threshold number of reviews. By way of example and not limitation, the threshold number of reviews may be 10, 20, 30, 40, 50, 60, 70, 80, 90, 100, or more than 100 reviews.

Accordingly, the disclosed embodiments are able to provide structure to unstructured sentiment data and then use that structured sentiment data to generate a score for the product. Consumers can consult the ranking score to determine whether to actually purchase the product. In this regard, the embodiments help reduce the likelihood of cart abandonment.

### Example Computer/Computer Systems

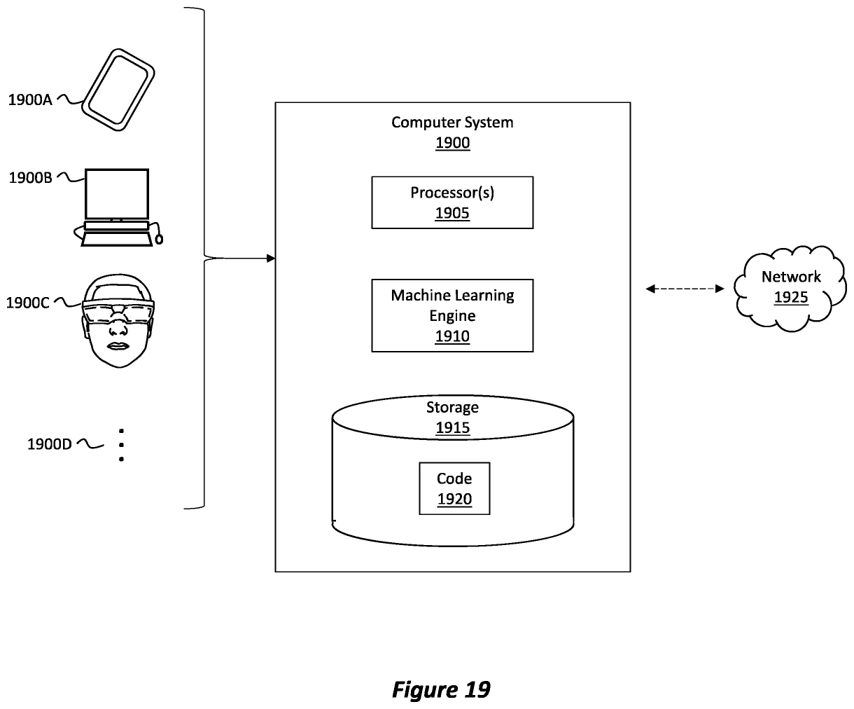

Attention will now be directed to FIG. 19 which illustrates an example computer system 1900 that may include and/or be used to perform any of the operations described herein. Computer system 1900 may take various different forms. For example, computer system 1900 may be embodied as a tablet 1900A, a desktop or laptop 1900B, a wearable device 1900C, a mobile device, a standalone device, or any other type of computing device, as represented by the ellipsis 1900D. Computer system 1900 may also be a distributed system that includes one or more connected computing components/devices that are in communication with computer system 1900.

In its most basic configuration, computer system 1900 includes various different components. FIG. 19 shows that computer system 1900 includes one or more processor(s) 1905 (aka a “hardware processing unit”), a machine learning engine 1910, and storage 1915.

Regarding the processor(s) 1905, it will be appreciated that the functionality described herein can be performed, at least in part, by one or more hardware logic components (e.g., the processor(s) 1905). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

The machine learning engine 1910 is represented of the ML engines mentioned thus far and may be implemented as a specific processing unit (e.g., a dedicated processing unit as described earlier) configured to perform one or more specialized operations for the computer system 1900. As used herein, the terms “executable module,” “executable component,” “component,” “module,” or “engine” can refer to hardware processing units or to software objects, routines, or methods that may be executed on computer system 1900. The different components, modules, engines, and services described herein may be implemented as objects or processors that execute on computer system 1900 (e.g. as separate threads). The machine learning engine 1910 (or perhaps even just the processor(s) 1905) can be configured to perform any of the disclosed method acts or other functionalities.

Storage 1915 may be physical system memory, which may be volatile, non-volatile, or some combination of the two. The term “memory” may also be used herein to refer to non-volatile mass storage such as physical storage media. If computer system 1900 is distributed, the processing, memory, and/or storage capability may be distributed as well.

Storage 1915 is shown as including executable instructions (i.e. code 1920). The executable instructions represent instructions that are executable by the processor(s) 1905 (or perhaps even the machine learning engine 1910) of computer system 1900 to perform the disclosed operations, such as those described in the various methods.

The disclosed embodiments may comprise or utilize a special-purpose or general-purpose computer including computer hardware, such as, for example, one or more processors (such as processor(s) 1905) and system memory (such as storage 1915), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Computer-readable media that carry computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1900 may also be connected (via a wired or wireless connection) to external sensors (e.g., one or more remote cameras) or devices via a network 1925. For example, computer system 1900 can communicate with any number devices or cloud services to obtain or process data. In some cases, network 1925 may itself be a cloud network. Furthermore, computer system 1900 may also be connected through one or more wired or wireless networks 1925 to remote/separate computer systems(s) that are configured to perform any of the processing described with regard to computer system 1900.

A “network,” like network 1925, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1900 will include one or more communication channels that are used to communicate with the network 1925.

Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system configured to provide semantic structure to unstructured product reviews of a product, where the product reviews are obtained from multiple different sources, and to use the semantically structured reviews to provide an independent score to the product, said computer system comprising:
one or more processors; and
one or more computer-readable hardware storage devices that store executable instructions that are executable by the one or more processors to cause the computer system to at least:
use a machine learning (ML) engine to identify one or more websites comprising content describing a particular product;
cause the ML engine to crawl to the one or more web sites and to extract, from the content included within the one or more web sites, sentiment data describing the product, the sentiment data comprising unstructured sentiment data and structured sentiment data;
generate a structured review for the product by causing the ML engine to use natural language processing (NLP) to determine semantic meanings for the unstructured sentiment data and by combining the semantic meanings with the structured sentiment data;
based on the structured review, generate a ranking score for the product; and
within a user interface that includes a selectable option for purchasing the product, display a scoring indicator within the user interface at a location that is proximate to the selectable option, wherein the scoring indicator includes:
the ranking score for the product,
a number of reviews that were examined to generate the structured review, and
a graphic that provides a visual cue reflecting a breakdown of how the ranking score was generated.

2. The computer system of claim 1, wherein the unstructured sentiment data includes text descriptions of the product.

3. The computer system of claim 1, wherein the structured sentiment data includes a star rating describing the product.

4. The computer system of claim 1, wherein the ranking score includes an overall score and a sub-category score that lists a particular score for a particular category for which the product is ranked.

5. The computer system of claim 1, wherein the scoring indicator includes a selectable expand option that, when selected, causes the user interface to further display a sub-score for a sub-category for which the product is ranked.

6. The computer system of claim 1, wherein the ranking score includes an overall score and a sub-category score that lists a particular score for a particular category for which the product is ranked, and wherein the sub-category is one of: a price category, a performance category, or a quality category.

7. The computer system of claim 6, wherein the ranking score includes an overall score and a sub-category score that lists a particular score for a particular category for which the product is ranked, and wherein the sub-category is one of: a popularity category, an availability category, a shipping category, or a merchant reliability category.

8. The computer system of claim 1, wherein the selectable option for purchasing the product is included within an electronic shopping cart.

9. The computer system of claim 1, wherein generating the ranking score for the product is performed by weighting text descriptions of the product differently than weighting star ratings of the product.

10. The computer system of claim 1, wherein the scoring indicator is emphasized in response to a determination a user of the user interface is attempting to navigate away from the user interface.

11. A method for providing semantic structure to unstructured product reviews of a product, where the product reviews are obtained from multiple different sources, and for using the semantically structured reviews to provide an independent score to the product, said method comprising:
using a machine learning (ML) engine to identify one or more websites comprising content describing a particular product;
causing the ML engine to crawl to the one or more web sites and to extract, from the content included within the one or more web sites, sentiment data describing the product, the sentiment data comprising unstructured sentiment data and structured sentiment data;
generating a structured review for the product by causing the ML engine to use natural language processing (NLP) to determine semantic meanings for the unstructured sentiment data and by combining the semantic meanings with the structured sentiment data;
based on the structured review, generating a ranking score for the product; and
within a user interface that includes a selectable option for purchasing the product, displaying a scoring indicator within the user interface at a location that is proximate to the selectable option, wherein the scoring indicator includes:
the ranking score for the product,
a number of reviews that were examined to generate the structured review, and
a graphic that provides a visual cue reflecting a breakdown of how the ranking score was generated.

12. The method of claim 11, wherein displaying the scoring indicator is performed when the number of reviews that were examined to generate the structured review satisfies a threshold number of reviews.

13. The method of claim 12, wherein the threshold number of reviews is 10 reviews.

14. The method of claim 12, wherein the threshold number of reviews is 50 reviews.

15. The method of claim 11, wherein identifying the one or more websites comprising the content describing the particular product is performed by first identifying a name and product features of the product and then performing a search using the name and product features to identify the one or more websites.

16. The method of claim 11, wherein the one or more websites includes a website not managed by a manufacturer of the product.

17. The method of claim 11, wherein the graphic is a block arc comprising different block portions that each represent a relative scoring percentage contribution that contributed to the ranking score.

18. The method of claim 17, wherein the block arc encloses an encapsulated area, and wherein the ranking score and the number of reviews are visually presented within the encapsulated area enclosed by the block arc.

19. The method of claim 11, wherein the unstructured sentiment data includes text descriptions of the product, and wherein the structured sentiment data includes a star rating describing the product.

20. One or more hardware storage devices that store instructions that are executable by one or more processors of a computer system to cause the computer system to at least:
use a machine learning (ML) engine to identify one or more websites comprising content describing a particular product;
cause the ML engine to crawl to the one or more web sites and to extract, from the content included within the one or more web sites, sentiment data describing the product, the sentiment data comprising unstructured sentiment data and structured sentiment data;
generate a structured review for the product by causing the ML engine to use natural language processing (NLP) to determine semantic meanings for the unstructured sentiment data and by combining the semantic meanings with the structured sentiment data;
based on the structured review, generate a ranking score for the product; and
within a user interface that includes a selectable option for purchasing the product, display a scoring indicator within the user interface at a location that is proximate to the selectable option, wherein the scoring indicator includes:
the ranking score for the product,
a number of reviews that were examined to generate the structured review, and
a graphic that provides a visual cue reflecting a breakdown of how the ranking score was generated.
